(19) United States
(12) Patent Application Publication
(10) Pub. No.: US 2002/0031218 A1
(43) Pub. Date: Mar. 14, 2002

(54) Encryption method relevant to all encryption procedures

(76) Inventor: Jen-Chiun Lin, Taipei City (TW)

Correspondence Address: WINSTON HSU, 5F, No. 389, Fu-Ho Road, Yung-Ho City, Taipei Hsien, 234, TW

(21) Appl. No.: 09/789,617

(22) Filed: Feb. 22, 2001

(30) Foreign Application Priority Data
Sep. 14, 2000 (TW) 89118786

(51) Int. Cl. H04L 9/28

(52) U.S. Cl. 380/28; 380/42

(57) ABSTRACT

An encryption method for enciphering a fixed-length plain text string with a given key to obtain a corresponding fixed-length enciphered text string. The encryption method includes giving the key and the plain text string, cooperating with the key by a startup algorithm to generate an encryption reference data, and cooperating with the encryption reference data by an encryption algorithm to encipher the plain text string into an enciphered text string. The encryption method inputs both a fixed-length input text string and the encryption reference data and following several specific steps, it outputs a fixed-length output text string. The encryption method further comprises a reset procedure for resetting the encryption reference data after enciphering the input text string.

### BACKGROUND OF THE INVENTION

1. Field of the Invention

The present invention relates to an encryption method, and more particularly, to an encryption method with a highly non-linear structure to decrease the possibility of cracking.

2. Description of the Prior Art

To prevent information from being intercepted and its content revealed while transmitting, it is very common to encrypt important information by specific encryption methods. Generally speaking, the most common form of encryption is to provide encryption key codes and plain texts for encryption using the encryption key codes, and then to obtain enciphered texts. After receiving the encryption key codes and the plain texts, the plain texts are separated into several plain text strings of fixed length by a specific method. Then, the plain text strings, using other key codes and another basic encryption method, are encrypted as ciphered text strings. Finally, a procedure is used to combine all ciphered text strings to obtain ciphered texts.

### SUMMARY OF THE INVENTION

It is an object of the present invention that a method is provided for enciphering and deciphering plain text strings of a fixed length that cooperate with key codes, provided by an encryption system of the present invention, to encrypt the plain text strings as enciphered strings. The present invention can be regarded as a basic composition block used in several different kinds of encryption systems, and the possibility of cracking is decreased due to its highly non-linear structure.

In accordance with the claimed invention, an encryption method is used for enciphering a fixed-length plain text string with a given key to obtain a corresponding fixed-length enciphered text string. The encryption method includes giving the key and the plain text string, and cooperating with the key by a startup algorithm to generate encryption reference data, and cooperating with the encryption reference data by an encryption algorithm to encipher the plain text string into an enciphered text string.

It is an advantage of the present invention to increase the complexities of all encryption steps to lower the possibility of cracking.

Those and other objectives of the present invention will no doubt become obvious to those of ordinary skill in the art after reading the following detailed description of the preferred embodiment which is illustrated in the various figures and drawings.

### BRIEF DESCRIPTION OF THE DRAWINGS

FIG. 1 is a block diagram of an encryption system according to the present invention encryption method.

FIG. 2 is a block diagram of a startup algorithm.

FIG. 3 is a block diagram of an encryption algorithm.

FIG. 4 is a detailed schematic diagram of a function block 22.

FIG. 5 is a detailed schematic diagram of a function block 26.

FIG. 6 is a detailed schematic diagram of a function block 28.

FIG. 7 is a sequencing flow chart of deciphering according to the present invention.

### DETAILED DESCRIPTION OF THE PREFERRED EMBODIMENT

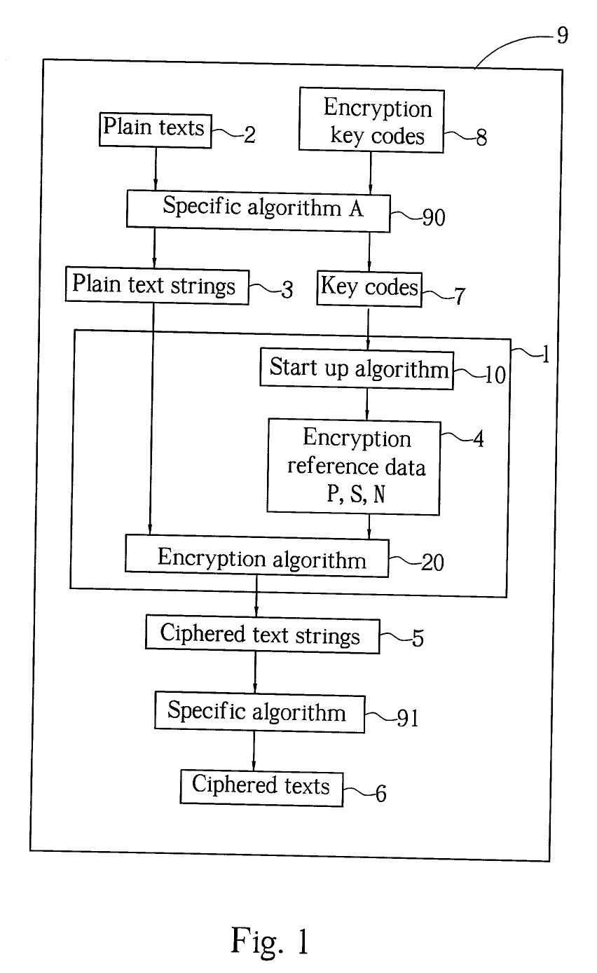

Please refer to FIG. 1 of a block diagram of an encryption system, represented by function block 9, according to the present invention encryption method 1. A plain text 2 and encryption key codes 8 are used as the inputs of the encryption system 9 and its output is a ciphered text 6. The encryption system 9 separates the plain text 2 into several plain text strings 3 of a fixed length by a specific algorithm A, represented as function block 90, and obtains key codes 7 used in the encryption method 1 from the encryption key codes 8. The main functions of the present invention encryption method 1 are to encrypt the plain text strings 3 as corresponding ciphered text strings 5 by the key codes 7, and to combine all ciphered text strings 5 into ciphered texts 6 using another specific algorithm B, represented as function block 91. The classical embodiment of the encryption system 9 is a block cipher structure. In other words, the specific algorithm A only separates the plain text 2 into several plain text strings 3 of a fixed length, and regards the encryption key codes 8 as key codes 7, and then encrypts all plain text strings 3 in turn. The other specific algorithm B only combines all ciphered text strings 5 into ciphered texts 6. The present invention encryption method can be also used in more complex encryption systems such as those with a stream cipher structure.

As shown in FIG. 1, the encryption method 1 according to the present invention includes two main function blocks 10 and 20. The key codes 7 are inputs of the function block 10, which is also a startup algorithm, and outputs encryption reference data 4. Both the plain text strings 3 and the encryption reference data 4 input into another function block 20, which is also an encryption algorithm, and outputs the ciphered text strings 5.

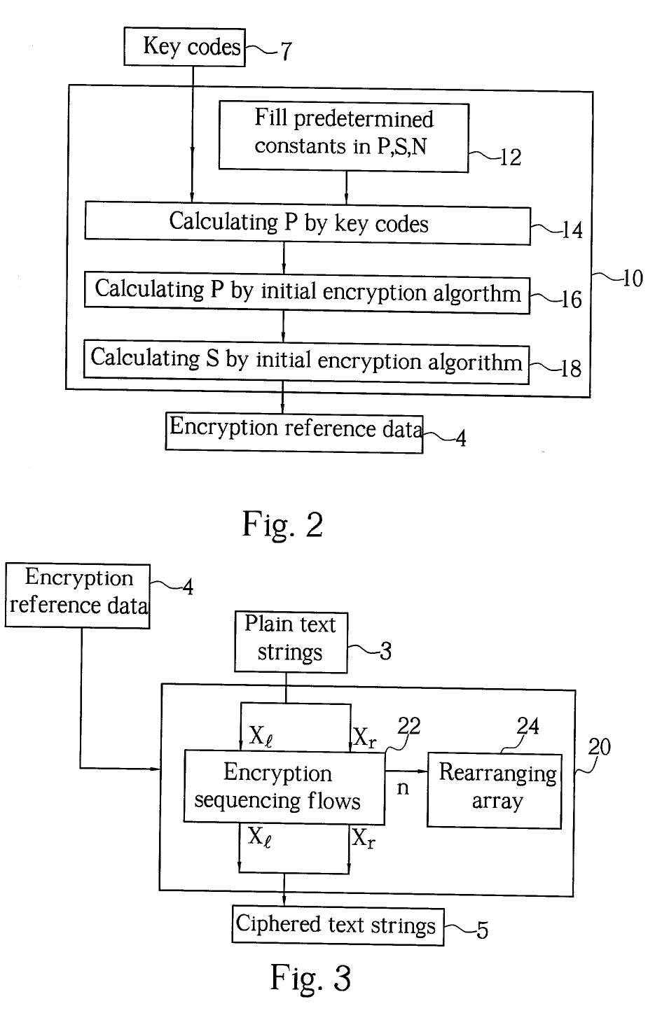

Please refer to FIG. 2 of a block diagram of the startup algorithm 10 shown in FIG. 1. The key codes 7 are used as inputs to the startup algorithm 10 and the encryption reference data 4 is the output consisting of three arrays, a sub-key array P, a corresponding sequencing array S, and an index array N. The sub-key array P includes 18 32-bit elements, the corresponding sequencing array S is a two-dimensional array with four 256-element one-dimensional arrays, and the index array N includes 16 32-bit elements. All three arrays are filled in predetermined constants as a function block 12. Following the function block 12 is a function block 14, and the first element of the sub-key array P and the former 32 bits of the key codes are under XOR operations. Then, the first element of the sub-key array P is refreshed using the results of these XOR operations. Thereafter, the second element of the sub-key array P and the latter 32 bits corresponding to the former 32 bits of the key codes are subjected to the XOR operations and are refreshed using the results of these XOR operations. All elements of the sub-key array P are refreshed in the aforementioned manner. If the total bits of the sub-key array P is less than that of the sub-key array P, the steps discussed above can also be completed by repeating sequences of the key codes.

The sub-key array P is recalculated by a function block 16, which is an initial encryption algorithm for inputting two 32-bit inputs and outputting two 32-bit outputs. This refreshing procedure of the sub-key array P has the following steps:

1) inputting two 32-bit inputs with all entries being zero, outputting the corresponding two 32-bit outputs according to the two 32-bit inputs by the initial encryption algorithm, and filling these two 32-bit outputs to the first two elements of the sub-key array P, respectively;

2) reinputting these two 32-bit outputs as two new 32-bit inputs to generate another two new 32-bit outputs and filling them in the next two elements of the sub-key array P;

3) repeating steps 1) and 2) until all elements of the sub-key array are refreshed.

The corresponding sequencing array S is also applied to the aforementioned steps to refresh its elements.

Please refer to FIG. 3 of a block diagram of the encryption method 20. The 64-bit plain text string 3 can be separated into two segments called Xl and Xr. Both the segments Xl and Xr are inputted into a function block 22, which also applies to the encryption reference data. Then, the two segments Xl and Xr are refreshed and combined together as ciphered text strings 5, or the outputs of the function block 22. The function block 22 simultaneously generates an array n for refreshing the index array N in a function block 24 and the array n has the same length as the array N. The function block 24 operates under the rule of exchanging the ith element of the index array with its n[I]th element, and the index array N of the encryption reference data 4 can be rearranged to increase the degree of complexity during all the encryption procedures.

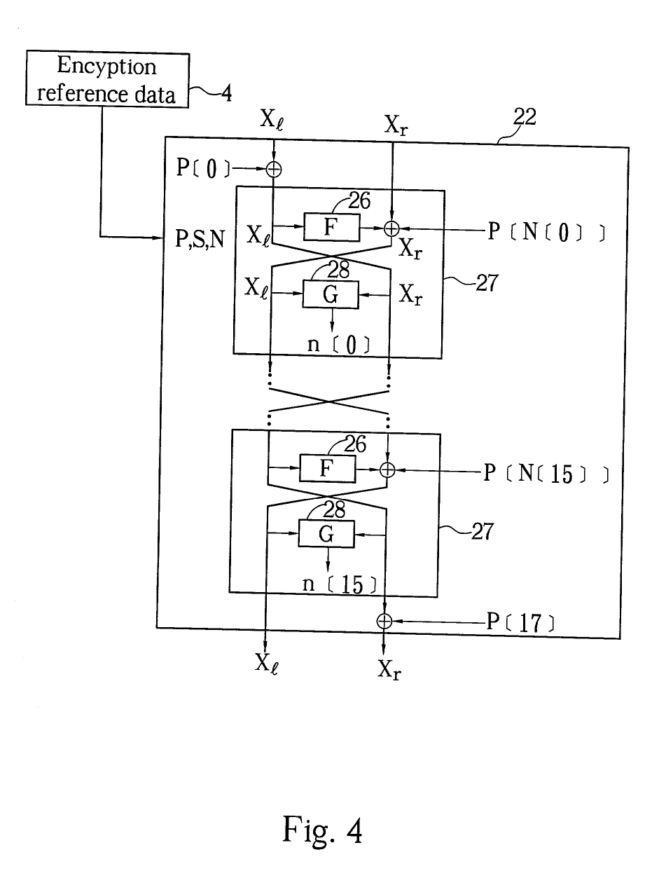

Please refer to FIG. 4 of a detailed schematic diagram of the function block 22. One segment Xl is under the XOR operation with P[0], or the first element of the sub-key array P, to be refreshed and then inputted into a first sequencing procedure 27 with the other segment Xr 27. In this procedure, Xl is inputted into a function block 26, and the output of the function block 26 is under XOR operations with Xr and P[N[0]] to refresh Xr. Then, the values of Xl and Xr are exchanged and both are inputted into a function block 28 to generate the first element of the array n represented as n[0]. After 16 repetitions of the sequencing procedure 27, P[N[I]] is used as a variable during the ith sequencing procedure to generate n[I]. Then, n[I] is under XOR operations with Xr and P[17] to refresh Xr once again.

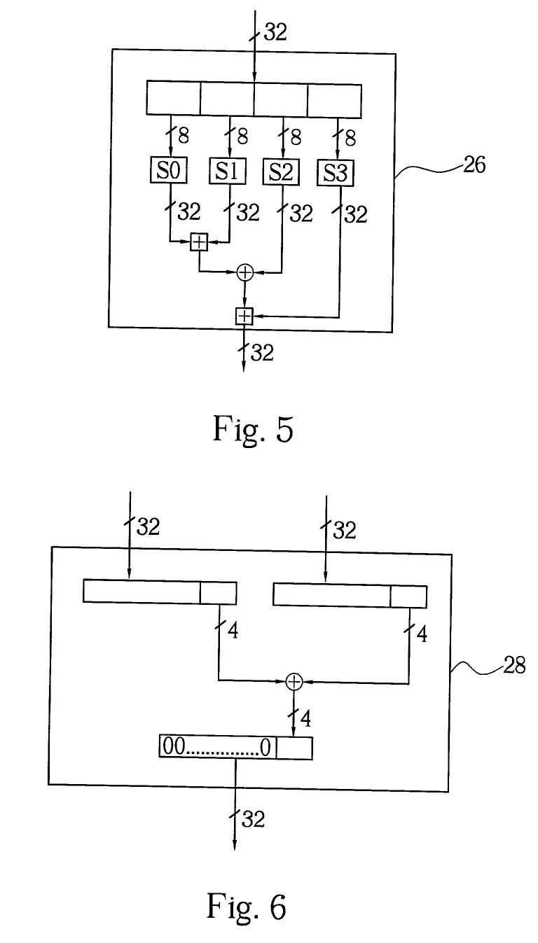

Please refer to FIG. 5 of a detailed schematic diagram of the function block 26. The function block 26 receives a 32-bit input and outputs a 32-bit output, which can be divided into four 8-bit segments represented as s0, s1, s2, and s3, respectively. The first 8 bits beginning from the most significant bit of the first one-dimensional array of the corresponding sequencing array N is s0, and the next 8 bits following s0 of the second one-dimensional array is s1. s2 and s3 are also obtained in the same manner, and the final output is (((s0+s1)XOR s2)+s3).

Please refer to FIG. 6 of a detailed schematic diagram of the function block 28. The function block 28 receives two 32-bit inputs and generates one 32-bit output. The last four bits of the two 32-bit inputs are under XOR operations to generate other four bits, whereby the new four bits are combined with the 28-bit zero entries to form the 32-bit output.

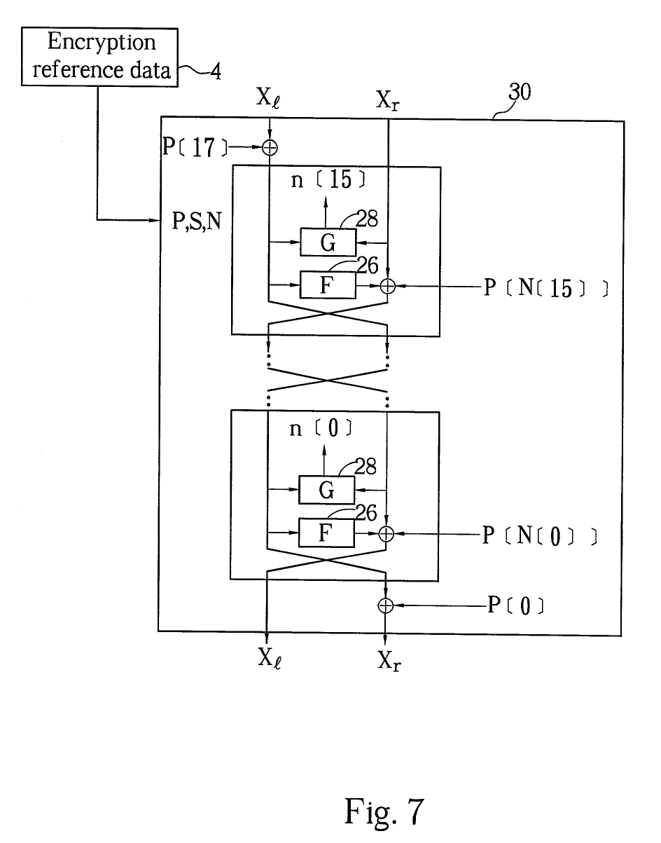

As shown in FIG. 7, while the plain text string is under encryption, the encryption reference data 4 is overwritten in the manner corresponding to the plain text. If applying the present invention for encrypting another plain text string, the outcome of the encryption is not only relevant to the key codes 7, but also to the overwritten encryption reference data 4 and its former plain text string. As a result, the ciphered texts generated by the present invention relate not only to the key codes 7, but also to all encryption procedures. Also, the arrangement increases the non-linearity of the present invention encryption method 1 to increase the difficulty of cracking.

For example, using a 128-bit key code to encrypt four 64-bit plain texts with the same content, the key code is 00 00 00 00 00 00 00 00 00 00 00 00 00 00 00 00, and the four 64-bit plain texts with the same content are 00 00 00 00 00 00 00 00, 00 00 00 00 00 00 00 00, 00 00 00 00 00 00 00 00, and 00 00 00 00 00 00 00 00. Using the encryption method 1 according to the present invention to encrypt the above four 64-bit plain texts, the outcome of the encryption is 98 38 97 4E 36 07 B3 D0, 90 FD BE 62 B0 6F DD D4, 90 FB B5 88 71 03 63 30, and 04 B5 63 6F 87 CE 28 AE, respectively. The outcome proves that ciphered texts according to the present invention relate not only with the key codes, but also with all encryption procedures regardless if the content of the plain texts and the key codes are the same or not.

In summary, the characteristic of the present invention is that the array n rearranges the index array N as description of the function block 24. This rearrangement overwrites the encryption reference data so that the encryption reference data is relevant not only to the key codes, but also to all encryption procedures so as to increase both the complexity and the non-linearity of the present invention in order to decrease the possibility of cracking.

There is a corresponding deciphering method for the present invention encryption method. By replacing the function block 22 with the function block 30 in FIG. 7, the ciphered texts are inputted with the key codes to regain the plain texts.

Those skilled in the art will readily observe that numerous modifications and alterations of the device may be made while retaining the teachings of the invention. Accordingly, the above disclosure should be construed as limited only by metes and bounds of the appended claims.

What is claimed is:

1. An encryption method for enciphering a fixed-length plain text string with a given key to obtain a corresponding fixed-length enciphered text string, the encryption method comprising:
giving the key and the plain text string
cooperating with the key by a startup algorithm to generate encryption reference data;
cooperating with the encryption reference data by an encryption algorithm to encipher the plain text string into an enciphered text string;
wherein the encryption method inputs both a fixed-length input text string and the encryption reference data and after several specific steps, outputs a fixed-length output text string, and the encryption method further comprising a reset procedure for resetting the encryption reference data after enciphering the input text string.

2. The encryption method of claim 1 wherein the encryption reference data comprising three arrays, which are a sub-key array, a corresponding sequencing array, and an index array.

3. The encryption method of claim 2 wherein the encryption algorithm receives both the input text string and the encryption reference data to obtain the output text string by the following steps:
1) separating the input text string into a left input text string and a right input text string, regarding a first element of the index array as an index, outputting an element of the sub-key array corresponding to the index, and combining the left or the right input text string with the index and the element of the sub-key array corresponding to the index, to calculate a left output, a right output, and a new index;
2) combining the left output, the right output, and the element of the sub-key array corresponding to a second element of the index array, to calculate the new left output, new right output, and the new index;
3) repeating step 2) for a fixed amount of time to obtain other new left outputs, other new right outputs, and other new indices;
4) combining the left output, the right output, an element of the sub-key array corresponding to a last element of the index array, and a last element of the key array to calculate the output text string corresponding to the input text string;
5) combining the new indices from steps 1) to 4) to rearrange the index array of the encryption reference data.

4. The encryption method of claim 2 wherein the startup algorithm comprising:
entering predetermined constants into the sub-key array, the sequencing array, and the index array;
cooperating with the sub-key array and the given key to recalculate the sub-key array by a specific procedure;
recalculating the sub-key array by an initial encryption algorithm;
recalculating the sequencing array by the initial encryption algorithm.

5. The encryption method of claim 4 wherein the initial encryption algorithm is the same as the encryption algorithm.
